(19) United States
(12) Patent Application Publication
(10) Pub. No.: US 2026/0052298 A1
(43) Pub. Date: Feb. 19, 2026

(54) TTML PLACEMENT INFLUENCED BY OBJECT DETECTION

(71) Applicant: Comcast Cable Communications, LLC, Philadelphia, PA (US)

(72) Inventors: Ryan McMurray, Arvada, CO (US); Christopher Weaver, Littleton, CO (US)

(21) Appl. No.: 18/804,573

(22) Filed: Aug. 14, 2024

(51) Int. Cl. H04N 21/81; G06V 20/40; H04N 21/234; H04N 21/25; H04N 21/8543

(52) U.S. Cl. CPC H04N 21/8126; G06V 20/40; H04N 21/23418; H04N 21/251; H04N 21/8543

(57) ABSTRACT

Systems, apparatuses, and methods are described for analyzing video content to detect and/or prioritize objects in the video content to determine placement of an overlay object that obscures a portion of the video content. The video content may be analyzed to determine areas of the video content to obscure, for example, by determining objects in the video content that have high priority to remain unobscured. Overlay objects that obscure video content may be placed over areas of low importance to the video content, for example, to enhance a viewer's experience of the content.

### BACKGROUND

Objects may be overlaid over a video to provide additional information to a viewer. Objects may provide details and/or context for the video, and/or they may provide accessibility features to enhance the viewing experience. The position of the objects being overlaid may be controlled, but are often positioned at a fixed place over the video and may be positioned over important and/or crucial elements of the video.

### SUMMARY

The following summary presents a simplified summary of certain features. The summary is not an extensive overview and is not intended to identify key or critical elements.

Systems, apparatuses, and methods are described for analyzing video content to detect and characterize objects in a video content to dynamically determine placement of an overlaid item (e.g., timed text markup language (TTML)). The overlaid item may be characterized, for example, by a time that the overlaid item is positioned over the video content as well as the shape and/or transparency of the overlaid item. The video content may also be analyzed, for example, to determine the position and/or shape of objects in the video content (e.g., content objects) and their importance to the video content. A viewer's experience of the video content may be enhanced, by determining the characteristics of content objects and areas around the content objects as well as the characteristics of the overlaid item including the shape and a period of obstruction. The viewer's experience may be enhanced, for example, by positioning an overlaid item over video content objects and/or areas based on the characteristics of the video content objects and the characteristics of the overlaid item.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example of a portion of video content.

FIG. 4 shows an example of a portion of video content with an object overlaid over the video content.

FIG. 5 is a flow chart showing an example method for learning objects to detect in video content.

FIG. 6 shows an example table comprising objects that may be detected in video content and the relative importance of the objects.

FIG. 7 shows an example of a portion of video content being analyzed to determine video content objects and object importance.

FIG. 8 shows an example of a portion of video content with an object overlaid over the video content based on objects detected in the video content.

FIGS. 9A through 9C is a flow chart showing an example method for determining objects in video content and determining a position to place an overlay object over the video content.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

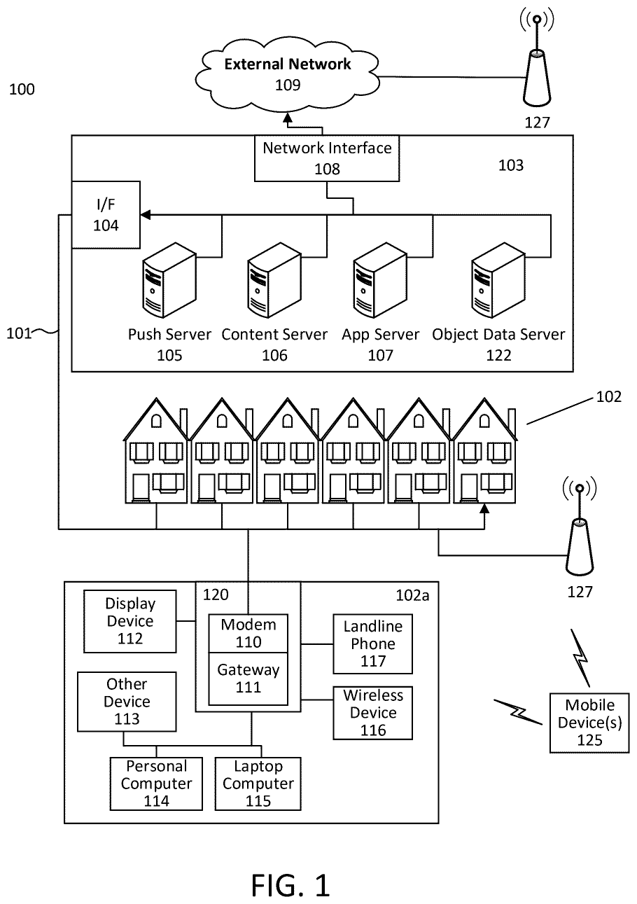

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122 (e.g., object data server) and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the object data server 122 (described below), additional push, content, and/or application servers, and/or other types of servers. Although shown separately, the push server 105, the content server 106, the application server 107, the object data server 122, and/or other server(s) may be combined. Also or alternatively, one or more servers may be part of the external network 109 and may be configured to communicate (e.g., via the local office 103) with computing devices located in or otherwise associated with one or more premises 102. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

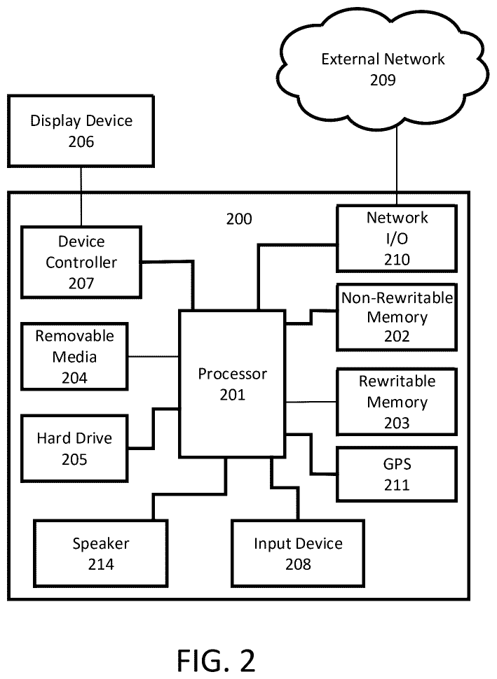

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a content server 106, an object data server 122, a wireless device 116, a personal computer 114, a laptop computer 115, mobile device(s) 125). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

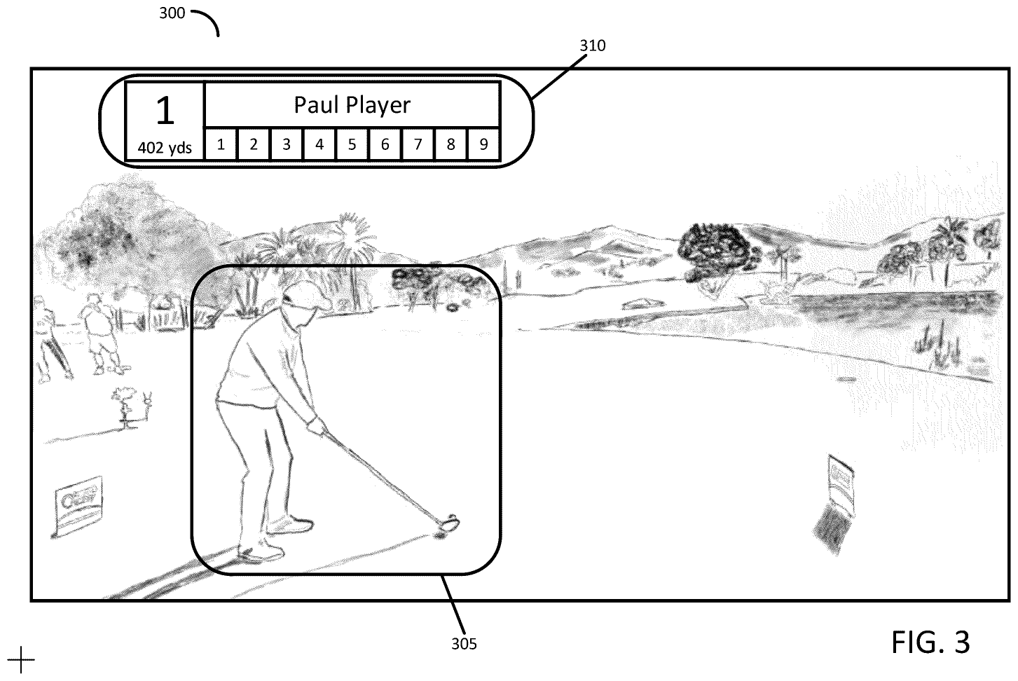

FIG. 3 shows an example of a portion of video content. Specifically, FIG. 3 shows an example of a portion of video content 300 comprising objects and details of different importance values. More important details and/or objects of the video content 300 may comprise a primary actor in, and/or action of, the scene 305 (e.g., a golfer preparing to tee off at a golf course) and inserted data 310 (e.g., data associated with a sport being watched, a graphic, etc.) that may be intended to be seen and/or enhance the portion of video content. Less important objects of the video content 300 may comprise, for example, other people (e.g., fans, journalists, other golfers, etc.), background scenery, various signs, and/or other objects that provide details of a low importance value to the primary actions of the piece of the video content.

Video content may comprise sports content, news content, streaming video, animated content, interviews, award ceremonies, entertainment content, and/or other types of content (e.g., movies, television shows, etc.). Video content may comprise a live video feed of a sporting event, a live video feed of an awards ceremony, a live video feed of a news program, a live video feed of an interview, a live video feed of a performance, a recorded video feed of a sporting event, a recorded video feed of an awards ceremony, a recorded video feed of a news program, a recorded video feed of an interview, and/or a recorded video feed of a performance.

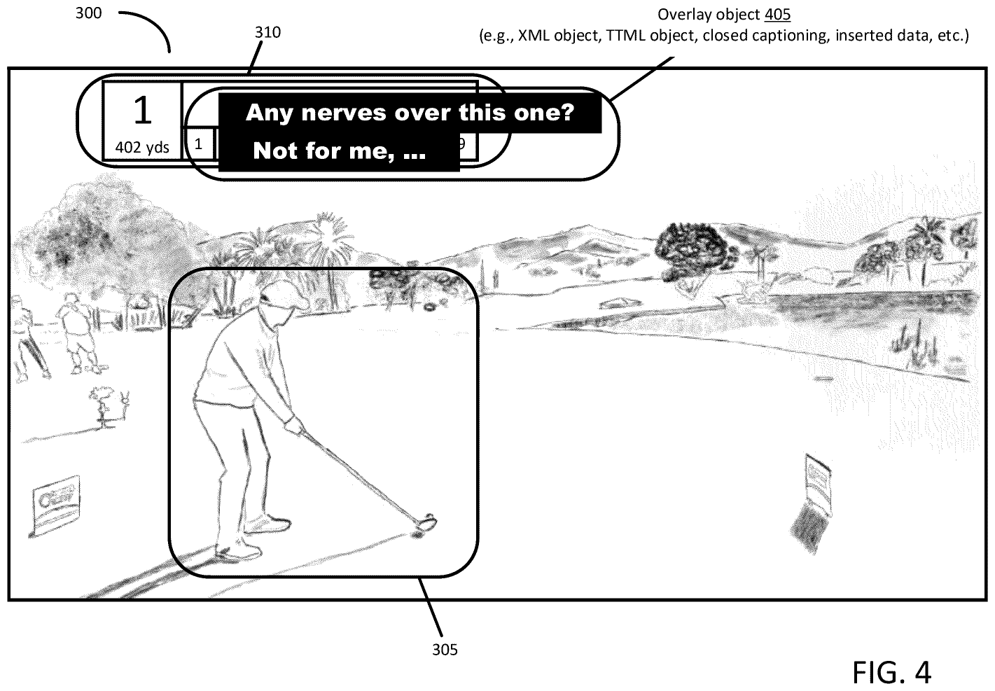

FIG. 4 shows an example of a portion of video content with an item (e.g., an overlay object) overlaid over the video content. Specifically, FIG. 4 shows an example of the portion of video content 300 with an overlay object 405 (e.g., closed captioning text) positioned over inserted data 310. Overlay objects may provide a benefit to a user and/or a provider of content, but may be positioned over important details and/or objects (e.g., the inserted data 310) in a way that may reduce the experience of the user. For example, as shown in FIG. 4, an overlay object 405 may be positioned over inserted data 310 and obscure information valuable to a viewer of, and/or producer of, the portion of video content 300 (e.g., the current golfer preparing to tee off and their current stroke count for a golf tournament) for a plurality of frames of video content. As another example, a user may benefit from having closed captioning to better understand what may be said in the video content 300, but information that provides context to the user about the video content 300 may be covered and the information lost to the user.

Additionally, a length of time (e.g., a period of obstruction, an overlay period, a defined time, etc.) an overlay object 405 covers video content 300 may be considered. The length of time may be included with details of the overlay object 405 (e.g., as supplemental content received with the overlay object). The length of time may alternatively be determined based on the type of object that is being overlaid. A length of time of a closed captioning text display may be determined, for example, based on the amount of words spoken in a certain period of time. A text display of a few words may not need to be displayed for as long as a text display of more words. The length of time may also be set by a rules packet. Rules packets may comprise rules and/or regulations. Regulations may be provided, for example, by country, state, and/or local governments. Rules may be, for example, controlled by ad servers, content providers, etc. Rules and/or regulations may provide details on formatting of the overlay object. Rules and/or regulations may provide, for example, details on font sizes and/or transparency values. Rules and/or regulations may provide, for example, a duration, a period of time, and/or a number of frames overlay objects are to cover or obscure regions or areas of a plurality of frames of the video content.

Continuity of placement may also be considered. It may be jarring to some users if overlay objects change position constantly. To reduce the number of shifting overlay items, a time threshold may be introduced. Using a time threshold, an overly object may be determined to have a short duration (e.g., less than the time threshold) or a long duration (e.g., greater than or equal to the time threshold). Overlay objects with a short duration may be overlaid at a standard position in the video content. The standard position may be determined, for example, by the overlay type, by a rules packet, as a setting, and/or by other standards. Alternatively, overlay objects with a short duration may be overlaid at the last overlay position. Overlay objects with a long duration, alternatively, may cover the less important objects and/or areas of the video content, determined dynamically, following methods described herein.

Overlay objects may comprise, for example, timed text markup language (TTML) objects or extensible markup language (XML) objects. Overlay objects may provide, for example, information to a user about video content being viewed, local and/or national information to be shared, secondary video content, and/or advertisements. Overlay objects may provide captioning of the video content and/or emergency alert information. Information about video content may comprise, for example, information about characters and/or the actors portraying them, statistics about players or teams of a sport, and/or information about objects in the video content (e.g., content objects). Overlay objects placed over less important details and/or content objects may enhance a user's experience of the video content, but overlay objects placed over important details and/or content objects may lessen the user's experience.

Video content may be analyzed to determine content objects, and importance values of the content objects in the video content. The video content may be analyzed, for example, using artificial intelligence (AI), machine learning, and/or large data sets. AI may be used to analyze the video content 300. AI allows machines to learn (e.g., machine learning) from training and/or prior experience and use the training and/or prior experience to react and/or perform tasks based on new inputs. AI may analyze the video content 300 and determine a number of content objects based on prior training. AI models may be trained to recognize content objects in general. AI models may be trained to recognize content objects for particular events, for example, a golf match that includes different people (e.g., golfers, reporters, fans, caddies, etc.), golf equipment (e.g., golf ball, golf clubs, a golf course, etc.), vegetation, mountain ranges, water hazards, etc. AI models may be contained on servers. An object data server 122 may comprise one or more content objects models, for example, a general AI content object model and/or a specific event AI content object model.

AI may be trained to recognize content objects in general. AI may be trained to recognize general content objects (e.g., balls, people, cars, etc.). A general AI content object model may be trained to determine general content objects and a general importance value for each of the content objects. A general AI content object model may be trained to recognize a tree and determine a low importance value for the tree, for example, because generally trees are background and are of low importance value to video content. AI may be trained to determine a car parked on a street without any people interacting with it may be less important, for example, than a car being driven or a parked car being broken into.

AI may be trained to recognize content objects in more specific situations. AI may be trained to determine the importance value of a content object for different and/or specific events. AI may be trained with a model based on golf tournaments, for example, to develop an AI content object model for golf tournaments. An AI content object model generated for golf tournaments may give golf balls and/or golf clubs a higher importance value than a general AI content object model. An AI content object model may be generated for a type of video content (e.g., a golf tournament). An AI content object model may be generated for a specific show (e.g., a specific late night talk show). The different AI object models may be tuned to provide context to where content objects may be found. AI may also be trained to recognize the type of video content being analyzed. AI analyzing video content may determine, for example, that the video content is about golf, if many golf related items and/or areas comprising driving ranges, greens, water hazards, and/or sand traps are detected.

AI may be trained to recognize particular people. AI may be trained to recognize general people of higher importance value in a crowd. People of higher importance value may be major entertainment stars, political leaders, sports stars, etc. A general AI model of particular people may be trained to recognize people having a higher importance value. Moreover, people having a higher importance value may depend on the specific situation, and AI may be trained to recognize particular people having a higher importance value in more specific situations. AI may be trained with a model based on golfers, for example, to recognize golfers in a golf tournament. An AI content object model trained on golfers may recognize golfers at golf tournaments, for example, based on a golfer's appearance, the clubs the golfer uses, and/or the clothing the golfer wears.

A computing device (e.g., an object data server 122) may comprise AI and/or a machine learning model to train AI. AI may use machine learning models and methods to learn to detect content objects in video content. Computing devices (e.g., an object data server 122) comprising AI and/or machine learning models to train AI may perform the methods described herein. Machine learning models may include logistic regression, multi nominal logistics regression, linear regression, support vector machines, naive Bayes, decision trains, k nearest neighbors, random forest, boosting, k-means, or hierarchical clustering. The steps of the methods described herein may be rearranged, steps of the methods described herein may be omitted, and other steps not described herein may be added to and/or included in the methods described herein.

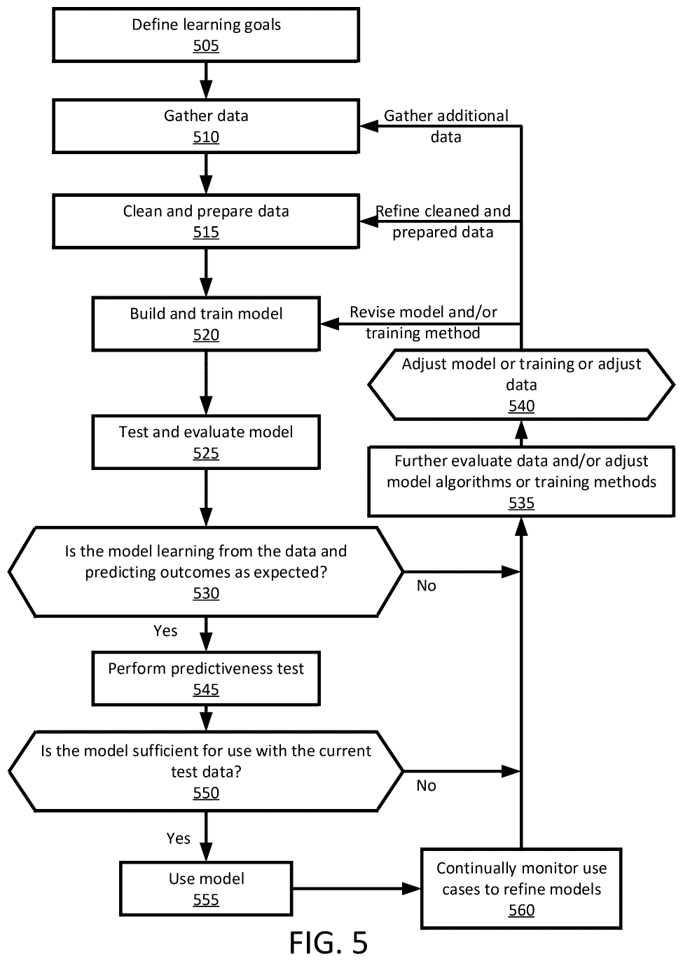

FIG. 5 is a flow chart showing an example method for learning objects to detect in video content. Specifically, FIG. 5 is a flow chart showing an example method for a computing device using AI to learn different content objects in video content and how content objects in video content may be determined. In step 505, learning goals may be determined and/or defined for a computing device (e.g., a computing device using AI). The learning goals may comprise determining content object types to detect. A general set of items common in video content (or in one or more types of video content) may be provided to the computing device, for example, for the computing device to detect general content objects common in video content. Data comprising images of balls (e.g., baseballs, bowling balls, golf balls, etc.) may be provided to the computing device, for example, to learn to detect balls in general. Data comprising images may comprise video and/or still images. Machine learning may allow different types of balls to be recognized. Machine learning may allow a computing device to learn where different types of balls may be used. A computing device may be trained to recognize a football and/or learn that a football may be used in a football game, for example, by training the computing device with video and/or images of a football being used by players of football. A computing device may be trained to recognize a golf ball and/or trained to recognize that a golf ball may be used for golf, for example, by training the computing device with video and/or images of a golf ball being used by golfers. A general content object detection model may be able to be trained to recognize objects common to general video content (e.g., people, places, things, etc.). Audio content associated with the video content may also be analyzed to determine context around content objects. Audio content directed towards and/or about content objects of the video content may be used to determine that those content objects are more important.

Learning goals may comprise determining the machine-learning algorithm to use. It may be determined, for example, to use one or more of logistic regression, multi nominal logistics regression, linear regression, support vector machines, naive Bayes, decision trains, k nearest neighbors, random forest, boosting, k-means, or hierarchical clustering.

Learning goals may comprise learning content objects of more specific types of video content. Data comprising a specific type of video and/or image content may be provided to a computing device, so that a computing device may learn to detect content objects, an importance value of a content object, and/or an amount of time that the object may have that importance value, for example, for that type of specific video content. Data comprising specific video and/or images of golf and/or golf related themes (e.g., golfers teeing off, golfers striking the ball, people watching a golf ball being struck and/or traveling from the point of contact, etc.) may be provided to a computing device to learn content object detection of golf related themes and/or content objects (e.g., golfers, golf balls, golf clubs, golf courses, etc.).

Learning goals may also comprise learning an importance value of content objects that may be detected. An importance value may be determined, for example, based on an amount of time a video focuses on a detected content object. It may be determined that a golf ball rolling on a green and nearing a hole may be more important than a golf ball in the hole after a period of time, for example, if the content object detection is of golf related items and based on an amount of time a video focuses on a golf ball before and after the golf ball is in the hole.

Learning goals may comprise learning a time (e.g., a duration) a content object may have some importance value. A content object may be important at one point in time, for example, but may become less important over time. A hole on a green of a golf course may be important as a golf ball approaches it, for example, but the hole may become unimportant a short time after the ball is in it. A car carrying an important passenger may be important as it pulls up to park, for example, but the car may become less important a short time after the important person exits it. The time may be expressed as a duration in time or may be expressed as a plurality of frames.

Learning goals may comprise, for example, learning advertisements and/or advertisement placement. Data comprising advertisements and/or advertisement placement may be provided to a computing device, for example, to learn to detect advertisements and/or where advertisements may be placed in video content.

In step 510, data related to the learning goals may be gathered. Data may be gathered over time. Data may be gathered from current data sets. Data may be purchased from data gathering and/or collections services. Data may be continued to be gathered over time and stored for the present and/or future models. Data may be acquired by monitoring use cases. Data comprising video, images, and/or audio related to golf (e.g., players, equipment, etc.), golf tournaments, and/or golf courses may be collected and used, for example, if a golf specific model is being developed. Gathered data may be explored, for example, to better understand the data and/or the validate the data. Validation may involve validating that the data may be a valid data set to train the model, for example, based on the learning goals set forth in step 505. Data may require cleaning, for example, based on the exploration and/or validation of data and/or based on inherent biases and/or collection methods of the data.

Data may be split. A portion of the data, for example, may go to teaching the model (e.g., a model development set). A portion of the data, for example, may go to training model testing (e.g., a model iterative testing set). A portion of the data, for example, may go to predictiveness testing (e.g., a model predictiveness testing set). Training model testing, for example, may be used to test models in a build stage. The predictiveness testing portion may be a portion of the data that has not been analyzed and may allow for a less biased predictiveness analysis.

In step 515, the data gathered in step 510 may be cleaned and/or prepared. Data used for machine learning may cleaned, for example, because data is central to preparing a model and/or using the model for analyzing video content. Data cleaning and/or preparation may comprise identifying and/or correcting errors and/or other issues in the data. Errors in the data may comprise, for example, missing and/or inconsistent data, redundant data, and/or outliers. Correcting errors in data may comprise, for example, correcting and/or removing missing, inconsistent, and/or redundant data and determining methods to handle outliers. Data preparation may include dealing with missing data. Missing data may arise, for example, from data collection and/or data transfer errors. Missing data may be determined from alternate data sets. Missing data may be determined from available data using data analysis techniques (e.g., central tendency determinations including mean, median, and/or mode). Alternatively, instances involving missing data may be removed from the data set. Finally, gathered data may be split for building and training the model.

In step 520, a model may be built and trained using the data gathered in step 510 and cleaned in step 515. The training may be built on a subset of gathered data and data unused in building the model may be used for testing. The amount of data used for training and the amount of data used for testing may be determined based on the learning goals defined and/or determined in step 505. The ratio of the amount of data used for training to the amount of data used for testing, for example, may be 4 to 1 for training data to testing data. The data used for training may be explored and/or algorithms (e.g., linear regression, decision trees, random forest, extreme gradient boosting (XGBoost), etc.) used to train may be chosen. The data may be analyzed to determine patterns. Patterns may be determined, for example, by choosing and using an appropriate training model (e.g., linear regression, support vector machine (SVMs), deep learning (DL), gradient boosting machines (GBMs), k-nearest neighbor (KNN), decision trees (DTs), random forests (RFs), etc.). Multiple trained models and/or cross-validation models may be built and trained. Models that have been built may be tested, for example, to optimize and/or further develop the models and/or to find patterns of outputs.

In step 525, the model may be tested. During a machine learning process, models may be tested periodically to verify, for example, that the model is learning from the provided training data comprising video and/or images, and that the model is predicting objects as defined by the learning goals determined and defined in step 505. Testing may be performed, for example, based on choosing and/or using an appropriate testing model (e.g., Matthews correlation coefficient (MCC), specificity, sensitivity, accuracy, a true negative ratio (TNR), etc.).

In step 530, it may be determined whether the current model may be sufficiently predictive or not. Sufficiency of the predictiveness may be, for example, based on the learning goals developed in step 505 and the testing and/or evaluation performed in step 525. The model algorithms and/or training methods may be adjusted and/or altered, for example, if it is determined that the model's predictive outcomes are poor. A model developed for golf may be determined to be poorly predicative, for example, if the model fails to determine golf balls, golf clubs, and/or a golf course. A model developed for recognizing golfers may be determined to be poorly predicative, for example, if the model fails to detect and/or recognize golfers (e.g., golfers in general and/or specific golfers in a tournament). Alternatively, it may also be determined that the model may be sufficiently predicative, but may require additional data for additional functionality and/or to account for use cases not accounted for in step 505. Alternatively, the model may be determined to be sufficiently predictive, for example, if in step 530 it is shown that the model is learning from the data and is able to make predicative outcomes as defined by the learning goals of step 505.

Machine learning may allow developers to adjust models, training methods, and/or data sets during the development process, for example, making machine learning an iterative process. The model may be adjusted in step 535, for example, if it was determined in step 530 that the model is not learning from the data or predicting outcomes as expected. Data sets may be adjusted by providing additional data set(s) by returning to step 510. Additional data sets may comprise data appropriate to object detection, for example, if the use case is to detect an object. Data may be refined, for example, by further cleaning and/or preparing data by returning to step 515. Alternatively, the model and/or training methods may also be revised, for example, by returning to step 520 to revise the model and/or the training method(s).

In step 540, it may be determined whether to gather additional data, further refine the current data, and/or revise the model and/or training method. the model may be adjusted, for example, if content object determination for certain content objects does not meet the goals defined in step 505. The data may be refined, for example, if it is determined outliers are causing spurious results by further cleaning and/or preparing the data in step 515. Alternatively, The model and/or training methods may be revised, for example, by changing model algorithms and/or training methods in step 520.

In step 530, alternatively, it may be determined that the model may be sufficiently predictive based on the development data set. A model may be determined to be sufficiently predictive, for example, based on a true positivity (TP) and/or true negativity (TN) rates. It may be determined, in step 545, whether the model may be sufficient for wider release, for example, if it is determined in step 530 that the model is sufficiently predictive.

In step 545, it may be determined whether the model may be ready for use case release, for example, by performing a predictiveness test using data set aside in step 510 for predictiveness testing. A model may be sufficiently predictive for most presented data as outlined in the learning goals of step 505, for example, but misidentify certain presented content objects or not identify them at all. A content object model for golf related content objects may be sufficiently predictive, for example, as determined by TN and/or TP rates, for certain objects (e.g., golfers, golf balls, golf clubs, etc.) but that model may not be sufficiently predictive, as determined by TN and/or TP rates, for certain other content objects (e.g., courses, course hazards, etc.).

In step 550, it may be determined that the predictiveness of the model may or may not be sufficient for use cases, for example, based on the predictiveness testing performed in step 545. It may be determined that the model may not be sufficiently predictive and that further data evaluation and/or adjustments to the model and/or training method may be made, for example, if it is determined that the model is not sufficiently predictive based on predictiveness tests performed in step 545. Further evaluation may be done by returning to step 535.

Alternatively, the model to detect content objects may be determined to be sufficient for use, for example, if, in step 550, it is determined that model is sufficiently predictive using predictiveness testing. In step 550, the model may be put into use to detect content objects, their importance values, the time that they may have that importance value, as well as other content object characteristics that may assist in determining placement of overlay objects.

The model may be used to provide further data and test cases for later revisions of the model. In step 560, the use cases of the model may be monitored and used to generate further data. The use cases may also be used to further evaluate the predictiveness and/or performance of the model. As data and/or evaluation continue revisions to the model may be developed by returning to step 535.

Other models based on content object detection may be comprised in video processing and/or video display software to detect content objects. The other models may be able to detect content objects, for example, but may rely on receiving additional data that may comprise the importance value of content objects and/or the time (e.g., a period, a plurality of frames, etc.) that content objects may be important. This additional data may be a part of a table with a key based on the content object. The additional data may be tuned for specific events and/or video content. A general table may provide a general importance value of a content object and a time that the content object has that importance value, for example, while an event and/or video content specific table may provide an importance value of a content object and a time that the content object has that importance value for the specific event and/or video content. A golf ball may be less important in a general table than in a golf event and/or video content specific table.

A general and/or specific content object detection table may be generated, for example, based on the machine learning method described herein in FIG. 5. The content object detection table may provide content objects, an importance value for each of the content objects, how long a content object may be important, and/or other details that may be important for analyzing a content object and/or providing additional considerations that may be used to enhance a viewer's experience. General and/or specific content object detection tables may be saved, stored, and/or contained on an object data server 122. A general content object detection table may provide a general content object importance value for content objects. Any car may generally be unimportant, but a car being pursued may be more important. A specific content object detection table may provide content object importance value for specific events. A specific content object detection table, for example, may be for a golf match. A specific content object detection table may append and/or adjust information from a general table. A specific content object detection table may still continue to detect content objects not included in the specific content object detection table, for example, by continuing to use a general content object detection table.

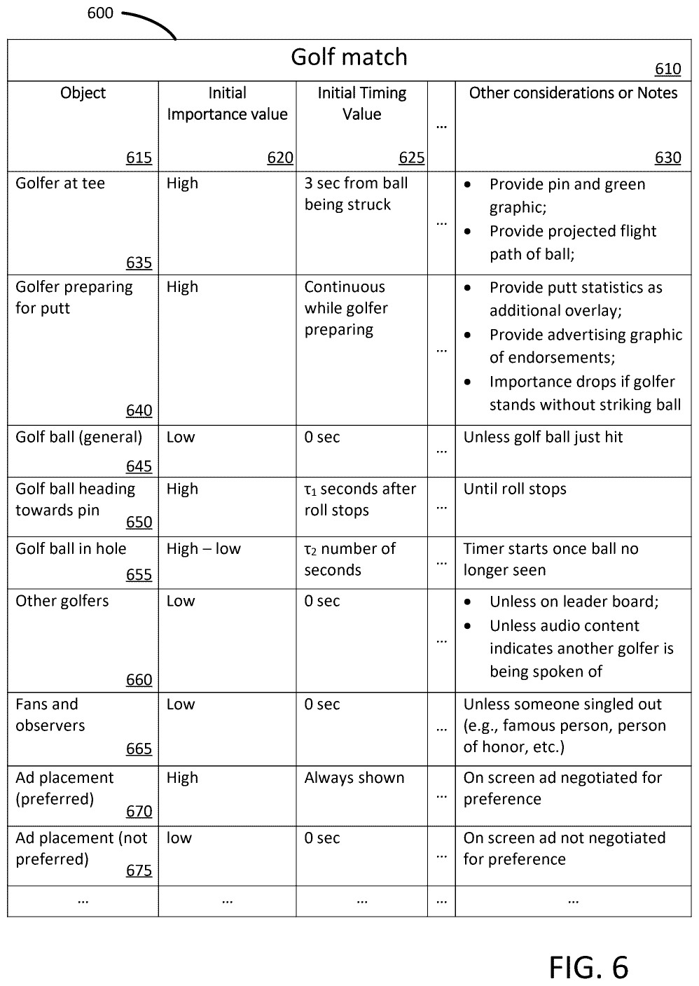

FIG. 6 shows an example table comprising objects that may be detected in video content and the relative importance value of the objects. Specifically, FIG. 6 shows an example of a specific content object table 600 comprising content objects, the importance values of the content objects, the time that importance values of the content object are relevant, and/or other considerations associated with a golf match. A computing device (e.g., an object data server 122) comprising AI may use the table 600 to analyze a video feed comprising a golf match to detect content objects and determine their importance value.

The table 600 may comprise a number of column headings. Column headings may comprise detected object 615, an initial importance value 620, an initial timing value 625, and/or other considerations or notes 630. The table may provide a table description 610. The table description 610 may designate the table as a general table. The table description 610 may indicate the specific event and/or video content type to use the table with.

FIG. 6, specifically, shows an example object table 600 with a table description 610 indicating that the table 600 is a golf match object detection table. The golf match detection table 600 may comprise content objects that may be associated with a golf match as indicated by the table description 610. Content objects associated with a golf match may comprise, for example, a golfer at a tee 635, a golfer preparing to putt 640, a golf ball in general 645 versus a golf ball heading toward a pin 650, a golf ball falling into a hole, and/or the golf ball in the hole 655, other golfers 660, fans and other observers 665, and/or preferred ad placements 670 and not preferred ad placements 675.

A content object indicated in object column 615 may be detected, and an initial importance value of the content object determined from column 620 of the table 600. Additionally, the table 600 for a golf match as indicated by the table description 610 may provide details on the time the content object may be important 625 (e.g., initial timing value) as well as any other considerations or notes 630 that may be associated with the content object indicated in object column 615. A golfer at a tee 635 of golf match as indicated by the table description 610 may have an initial importance value of high, for example, because it has been determined in training that a golfer at a tee 635 is about to tee off. The importance value of the golfer at the tee 635 becomes less important, for example, after the golfer at the tee 635 strikes the ball, and the importance value of the golf ball heading towards the pin 650 may become high. It may be determined that the initial timing value 625 may decrease 3 seconds after striking the ball, for example, based on machine learning as described herein in FIG. 5. The initial timing value 625 may be associated with a plurality of frames that the object 615 (e.g., content object) has an associated importance value 620. Additionally, other considerations and/or notes 630 associated with a golfer at a tee 635 may include instructions on providing a pin and/or green graphic to indicate the position of the pin and/or green that the golfer at the tee 635 may be driving to. Other considerations may include using AI to overlay the flight path of the ball as it travels from the tee toward the pin and/or statistics associated with the golfer.

As video content progresses (e.g., as different frames are viewed) different content objects may come into or may exit the field of view, and/or content objects may have their importance values change. An importance value may shift, for example, from the golfer at the tee 635 being more important than the golf ball 650 to the golf ball heading towards the pin 650 being more important than the golfer at the tee 635 at a time subsequent to the golfer striking the golf ball. Importance values may shift again, for example, to the golfer preparing to putt 640, and the importance values may shift yet again, for example, as the golf ball approaches the hole until finally the golf ball is in the hole 655. A content object detection table 600 may consider these shifting levels of importance, for example, by using the initial timing value 625 and/or other considerations and notes.

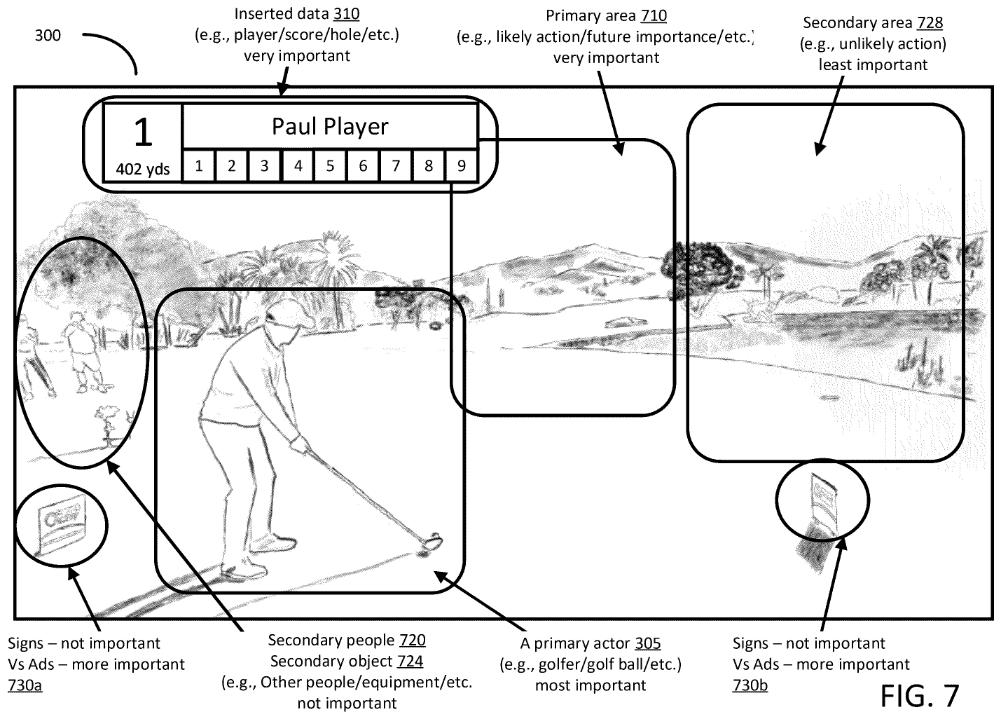

FIG. 7 shows an example of a portion of video content being analyzed to determine video content objects (e.g., content objects) and an object (e.g., content object) importance value. Specifically, FIG. 7 shows an example of video content 300 comprising more important content objects including a primary actor 305 (e.g., a golfer preparing to tee off at a golf tournament) and inserted data 310 (e.g., a graphic, player score of a golfer at a golf tournament, an overlay object, etc.) and also, one or more less important content objects (e.g., background scenery, background actors, etc.). Content objects may comprise players in a sporting event, individuals in news content, characters or actors in entertainment content, individuals in an interview or awards show, a score box, a chyron, items or regions of video content referenced or used by individuals of the video content, and/or a portion of a frame showing an advertisement

AI may analyze video content 300 and compare the details to models developed during training to determine that there are three people, two without golf clubs and one with a golf club, there are mountains, there is a lake, there are two signs, and there are trees of different species. An AI model may be trained, for example, to recognize the features of the golf course shown in the video content 300 to determine the golf course, the hole the golfer is on, the range to the pin, hazards that may be associated with the hole, and/or statistics related to the hole.

Video content may comprise primary actors and background actors, for example, where primary actors are important to the scene and secondary actors provide context. A primary actor, for example, will provide important details to video content 300. A primary actor may speak. A primary actor may be a designated primary actor. A primary actor may have been a primary actor in a portion of video content appearing at a time before the portion of the video content 300 shown in FIGS. 3 and 4. Secondary actors may be a part of background scenery. Secondary actors may appear momentarily and/or infrequently. Secondary actors may be looking at or interacting with primary actors.

AI may analyze video content 300, for example, to determine that, of three people in the video content 300, a person (e.g., a golfer) holding a golf club, at a golf tee, on a golf course, during a golf match is more important than other people standing without golf clubs watching the person holding the golf club. The golfer (e.g., the person holding a golf club) may be determined to be a primary actor 305, for example, based on the golfer holding the golf club and preparing to tee off during a golf tournament. The other two people may be determined to be secondary actors 720 (e.g., journalists, fans, other golfers, etc.), for example, based on the two people watching the primary actor 305, the two people not holding golf clubs and/or holding cameras.

Video content 300 may also comprise primary (e.g., more important content objects) and secondary objects (e.g., less important content objects) and/or primary areas (e.g., more important regions) and secondary areas (e.g., less important regions). Primary content objects may comprise content objects a primary actor 305 may interact with. Primary content objects may comprise a golf club and/or a golf ball, for example, if a primary actor 305 is a golfer preparing to tee off at a golf course. Secondary objects may comprise content objects a secondary actor is interacting with and/or a content object or object(s) not being interacted with by either a primary or a secondary actor. Secondary content objects may comprise a camera 724 and/or signs 730a and 730b, for example, if video content 300 is of a golf match and the camera 724 is directed toward the primary actor 720 (e.g., the golfer) and/or the signs 730a and 730b are placed around the golf course at particular locations to be seen. Moreover, primary content objects and/or primary areas may continue to be primary content objects and/or primary areas at a time after a primary actor is no longer in the video content 300. A golf ball by itself may be considered a primary content object, for example, if it is struck by a golfer driving towards a green in a golf tournament. A primary content object may be determined, for example, based on video content being focused on and/or video content following the content object.

A primary area 710 may comprise an area, for example, where a primary actor is interacting with their environment. A primary area may comprise an area, for example, where primary content objects are and/or are moving through. A primary area may be an anticipated area, for example, where it is expected some action will take place. A primary area 710 may be an area, for example, where a primary content object (e.g., a golf ball) hit by a primary actor (e.g., a golfer at a golf tournament) is anticipated (e.g., projected) to move through. AI may analyze the video content 300 to determine the primary area 710 (e.g., a projected path of a golf ball), for example, by determining the golf course the golf tournament is at, the hole the golfer is on, the position of the pin for the hole of the tee, and project a likely path the golf ball will take if hit by the golfer. A secondary area may comprise an area (e.g., a region) of the video content, for example, where primary actors and/or primary content objects are not located and/or where primary actors and/or primary content objects are not anticipated (e.g., projected) to move through. AI may analyze the video content 300 to determine the secondary area 728, for example, by determining that a golf ball struck by the golfer is unlikely to pass through this area.

Signs 730a and 730b may be considered a secondary content object, for example, because a primary actor may not be interacting with them and/or they are a part of a secondary area for example. Alternatively, if a sign comprises information that may be considered important, for example, the sign may be considered a primary content object. The sign may, for example, comprise advertising information intended to reach viewers of video content. Advertising information may comprise, for example, information related to a sponsor of a golf tournament. AI may be trained to recognize details on a sign to distinguish between important and unimportant information and, in turn, whether a sign is a primary or secondary content object. Sign 730a, for example, may be determined to be a secondary content object, and sign 730b, for example, may be determined to be a primary content object.

Objects in video content (e.g., content objects) may have different importance values. The importance values of content objects may indicate the priority of a content object to remain unobscured. Primary content objects may have the highest importance value, while secondary content objects may have different values of lesser importance. An importance value of a content object may be determined, for example, by analyzing the content object, the position of the content object in the video content, other content objects around the object, etc. A golf ball in video content about golf may be more important, for example, than a golf ball in a police procedural. A police officer may be more important in a police procedural, for example, than a police officer in a sitcom taking place in a coffee shop. People standing talking may be more important in a sitcom taking place in a coffee shop, for example, than people standing talking on a golf course of a golf tournament.

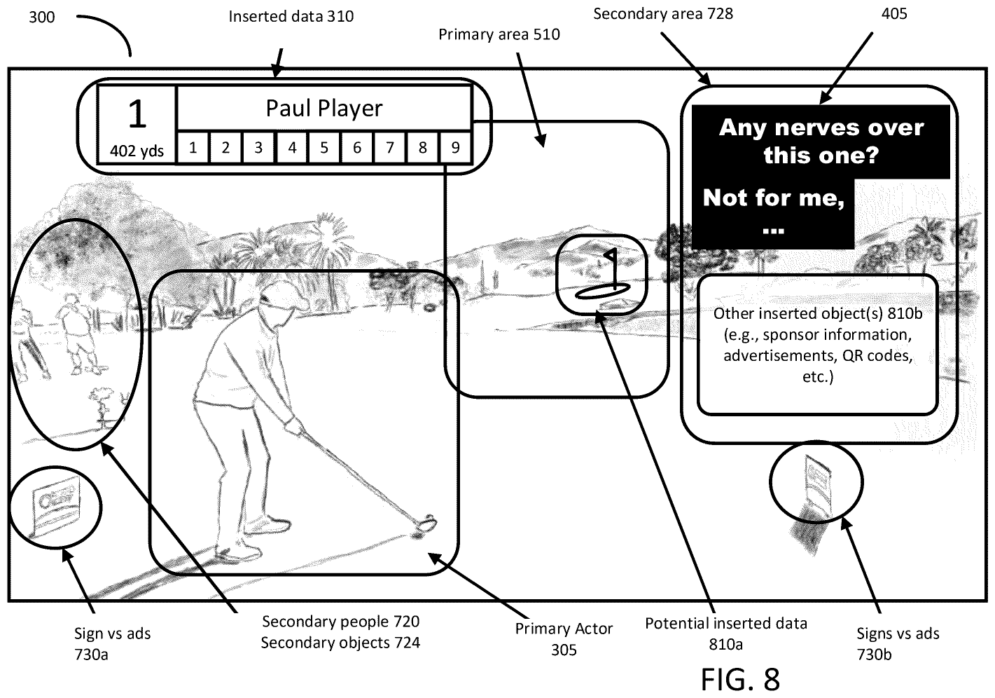

FIG. 8 shows an example of a portion of video content with an item (e.g., an overlay object) overlaid over the video content based on objects (e.g., content objects) detected in the video content. It may be determined that the secondary area 728 may be an unlikely area for content objects and/or actions with a high importance value to take place. An overlay object 405 may be inserted in a secondary area 728, for example, that has been determined to be less important for a time (e.g., a plurality of frames of the video content) that an overlaid item may cover and/or obscure the video content. The less importance of a secondary area or region of video content may indicate the lower priority of the area or region to remain unobscured by an overlay object.

Other items may be positioned over video content. The positioning of the other items, for example, may also be based on the characteristics of the overlay item (e.g., size and/or shape of the object, a time that the object may cover and/or obscure the video content, etc.). Other items may comprise potentially inserted data 810a and/or other inserted items 810b (e.g., sponsor information, advertisements, quick-response (QR) codes, etc.). A potentially inserted item may comprise graphics to show hidden details and/or anticipated action. Potentially inserted items may comprise, for example, a graphic of a green and/or a pin and/or a projected path of a golf ball in a golf match. Other inserted items (e.g., QR codes) may provide, for example, details on a golfer, gear that the golfer may use, and/or sponsorship deals the golfer may be involved in.

A computing device (e.g., an object data server 122, a content server 106, a video distribution site, etc.) may receive a portion (e.g., a plurality of frames) of video content and analyze the plurality of frames of the video content for different content objects in one or more frames of the plurality of frames of video content. The computing device may determine content objects having minimum importance value, their time (e.g., one or more frames) having that importance value, and/or their locations (e.g., the area or region) in the video content. The computing device may store this information in a supplemental file (e.g., a metadata file) that may be associated with the video content prior to the video content being viewed. Alternatively, the computing device may analyze a portion (e.g., a plurality of frames) of video content as it may be sent (e.g., transmitted) to a user device, for example, for an event that may be live (e.g., a live concert, a sporting event, and/or any live transmission).

The computing device (e.g., an object data server 122, a content sever 106, a video distribution site, etc.) may include supplemental data (e.g., metadata) associated with the video content that includes content objects having a minimum importance value, their time (e.g., a period, a plurality of frames, etc.) having that importance value, and/or their locations (e.g., regions, areas, etc.) in the video content. The computing device may also overlay items (e.g., overlay objects) over video content, for example, based on the information concerning content objects in the video content, their importance value, their time (e.g., a period, a plurality of frames, etc.) having that importance value, and/or the location of the content object and/or information associated with the overlay objects (e.g., a size, an insertion period, etc.). Alternatively, a second computing device (e.g., a smart television, a local network server, etc.) may overlay the overlay objects over regions or areas of the portion (e.g., a plurality of frames) of video content, for example, as they receive the portion (e.g., a plurality of frames) of video content along with the supplemental data and/or overlay objects that are to be overlaid over the video content. Determination of where to place an overlay object over regions or areas of video content for a plurality of frames of the video content may be based on the content objects, their importance value, and the time they may be important as well as details associated with the overlay object including the size of the overlay object, how long (e.g., an insertion period, a duration of insertion, a plurality of frames) the item may be overlaid over video content, etc. Overlay objects may comprise a uniform resource locator (URL), a hashtag, a quick response (QR) code, information about the video content, identification of an individual in the video content, identification of a sponsor of the video content, an animation, an advertisement, a chyron, a nameplate, a picture-in-picture, a TTML object, a timer, a ticker, a graphic, a caption, and/or an XML object. This list of overlay objects is not exclusive. New overlay objects, for example, may be created or developed as technology advances.

A computing device (e.g., an object data server 122, a content server 106, a video distribution site, etc.) may comprise AI to analyze content objects in a portion of video content. The AI may use content object detection tables as described herein in FIG. 6 to determine content objects in the portion of video content, the importance value of each of the content objects, and how long they may have that importance value. Computing devices (e.g., an object data server 122) comprising AI may perform the methods described herein. The steps of the methods described herein may be rearranged, steps of the methods described herein may be omitted, and/or other steps not described herein may be added to and/or included in the methods described herein. The steps described in the methods herein may be done continuously. The steps described herein may be performed, for example, as a video is prepared for streaming. The steps described herein may be performed based on data provided for in a supplemental data file (e.g., metadata).

The determination of the placement of any overlay object may be performed dynamically and may be based on the importance value of content objects in the video content, an insertion period that content objects in the video may be covered or obscured by an overlay object, the size of the overlay object, and/or one or more rules packets. The insertion period (e.g., a number of frames) may be a time value received as supplemental data associated with the overlay object, defined by the one or more rules packet, determined at the time of placement, previously configured, and/or determined by profile settings. Placement of the overlay object, moreover, may be based on a projected importance. For example, the secondary area 728 of FIG. 8 may be determined to be an area of low importance based on the secondary area 728 not being the primary area 520 around the green and/or anticipated path of a golf ball struck by the primary actor 305.

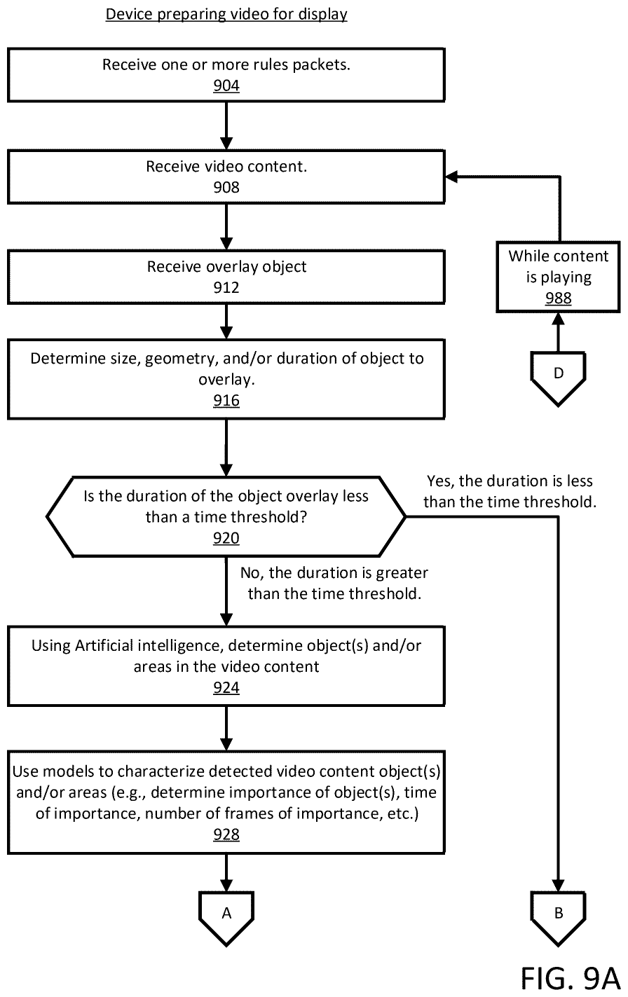

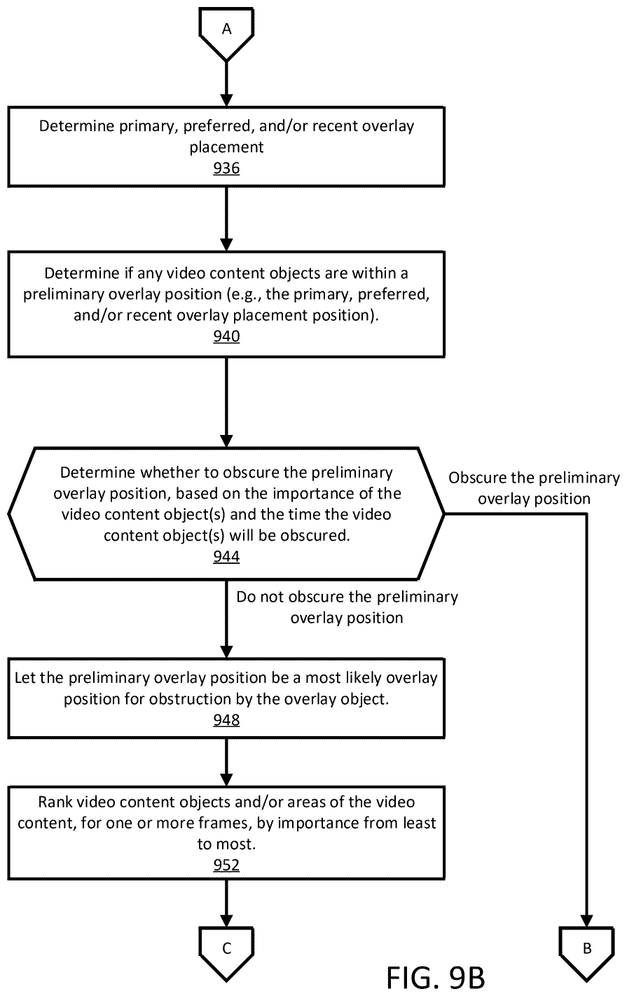

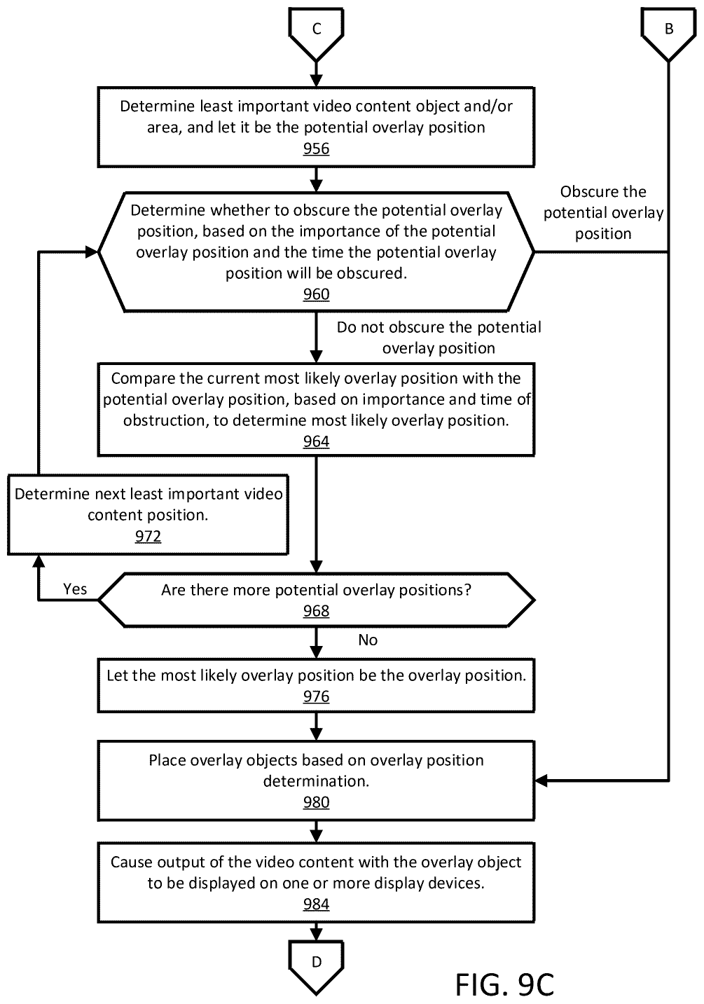

FIGS. 9A through 9C is a flow chart showing an example method for determining objects in video content (e.g., content objects) and determining a position to place an overlay object (e.g., an XML object, a TTML object, etc.) over the video content. The steps described in FIGS. 9A through 9C may be done continuously (e.g., dynamically), for example, as content is prepared for streaming and/or viewing, by a computing device (e.g., a content server 106, an object data server 122, a mobile device 125, a wireless device 116, a personal computer 114, a laptop computer 115, etc.) as described in FIG. 2.

In step 904 of FIG. 9A, the computing device may receive one or more rules packets. The rules packets may be from, for example, content providers and/or government agencies. The rules packet(s) may comprise rules on sizes and/or shapes of overlay objects, time periods that the overlay objects may be overlaid over video content, transparency and/or colors (e.g., background colors, font colors, etc.) of the overlay object, and/or general instructions of how to display overlay objects over video content.

In step 908, the computing device may receive the video content. The video content may be a portion (e.g., a plurality of frames) of a larger piece of video content, or the video content may be the entire piece of video content. The video content may be sent (e.g., transmitted), for example, from a streaming service, a content server 106, memory of the computing device (e.g., a wireless device 116, a personal computer 114, a laptop computer 115, etc.) playing the video content, and/or from any other provider of video content.

The video content analyzed in the method described in FIGS. 9A through 9C may be a portion (e.g., one or more frames) of the video content received. The video content analyzed, for example, may be the portion of the video content that is currently being played by a user. A portion of video content that is currently being played may comprise a plurality of frames before a current frame and/or a plurality of frames after the current frame. During playback of the video content, for example, analysis of a plurality of frames of video content around the current frame may continue to be performed. As shown in step 988, analysis of the video content may be performed, for example, while the video content is being played.

In step 912, an overlay object, that is to be overlaid over the video content, may be received. Overlay objects may be sent (e.g., transmitted) from a server (e.g., a content server 106). Also, or alternatively, the overlay object may be determined by the computing device preparing the video content for a display device. TTML and/or closed captioning, for example, may be determined as the video content is being played. Overlay objects may comprise text, graphics, logos, watermarks, promotions, callouts, live score updates, live polls, chat feeds, transition effects, links, interactive items, and/or the like. The overlay objects may comprise pre-recorded objects that are prepared in advance of video content playback and/or real-time objects that are prepared during playback of the video content. Overlay objects prepared during playback may be generated by the computing device preparing the video content for display and/or by the server preparing the video content for transmission.

Supplemental data (e.g., metadata) may be received with the overlay object that provides details of the overlay object. The supplemental data may comprise a size and/or shape of the overlay object, transparency information of the overlay object, and/or the overlay period (e.g., how long the overlay object is to be overlaid, the overlay duration, the obstruction time of the video content, etc.). The supplemental data may also comprise other details associated with how the overlay object is to be overlaid over video content.

In step 916, analysis of an overlay object may be performed. The overlay object may be analyzed dynamically, for example, to determine a size and/or a shape of the overlay object and/or an insertion period (e.g., duration). Details of overlay objects may also be provided as part of an overlay package comprising the overlay object and supplemental data (e.g., metadata). The size and/or shape of the overlay object provides details on how much of the video content will be obscured by the overlay object. The insertion period provides details on the time frame (e.g., the number of frames) that a portion (e.g., regions or areas) of the video content may be obscured. The size and/or shape and the insertion period of the overlay object, allows the computing device to determine the regions, areas, and/or content objects, of one or more frames of a plurality of frames, of the video content that the overlay object may cover or obscure. Details of an overlay object may also comprise who provided the overlay object, an importance to place the overlay object, etc. Who provided the overlay object may comprise the computing device preparing an overlay object in real time (e.g., TTML, closed captioning, real time data, etc.); it may also comprise the content provider (e.g., the sponsor of an event, the owner of a service providing the video content, etc.), and/or a government agency (e.g., public service announcement). The importance of the overlay object provider to have an overlay object (e.g., the provider's message) seen may be a consideration in overlay object placement. A public service announcement, for example, may want to cover important objects in video content in order to ensure that the public service announcement is seen by as many people in the community as possible.

A time threshold may be used to limit dynamic placement of overlay objects to overlay objects that have a sufficiently long insertion period. The time threshold may be a setting a user may adjust. A user may decide that fewer overlay objects should be dynamically placed, for example, by setting a long time threshold. Alternatively, a user may decide that all overlay objects should be dynamically placed, for example, by setting the time threshold to zero. A time threshold may also be a part of a rules packet. Certain types of overlay objects may be determined to always show up at a particular place in video content and for a certain duration. Emergency messages, for example, may be set by regulations to always appear across the top portion of video content for a minimum insertion period. Content providers may also provide time thresholds based on certain overlay types and/or associated with certain content. Content providers may provide certain advertisers, for example, with the option to place overlay objects at locations in video content that the advertiser finds most beneficial for their brand. The sponsors of a golf tournament, for example, may determine to have overlay objects emphasizing their products appear at certain places in video content and for a certain length of time rather than be dynamically placed.

In step 920, the insertion period of the overlaid object may be compared to the time threshold. The overlay object may be determined to be placed at a standard location, a location outlined in a rules packet, the location of the last overlay object, and/or a location determined by an advertiser at step 980 of FIG. 9C, for example, if it is determined, in step 920 of FIG. 9A, that the insertion period of the overlay object is less than the time threshold. Alternatively, the device may determine video content objects in step 924, for example, before determining the placement of the overlay object, if it is determined, in step 920, that the duration of the overlay object is greater than or equal to the time threshold.

In step 924, video content may be analyzed to determine and/or identify video content objects. Video content objects may be determined and/or identified, for example, using AI and/or trained object detection models as described herein in FIG. 5. Content object detection may be done prior to viewing on video content that may be stored (e.g., in a content server 106). Alternatively, content object detection may be done in real time, for example, for a live event (e.g., a golf match). Portions of the video content may be analyzed dynamically. A plurality of frames of the video content, for example, may be analyzed to determine content objects that appear in regions or areas of the video content for one or more frames of the plurality of frames of video content.

In step 928, the video content objects, detected in step 924, in a plurality of frames of the video content may be characterized. Video content objects may be characterized, for example, based on their importance values and the time (e.g., the duration, a number of frames, etc.) that they may have that importance value. The importance value of a video content may indicate the priority of the content object to remain unobscured while the video content is playing. Content objects may be characterized, for example, using an object detection table as described herein in FIG. 6. A computing device (e.g., an object data server 122, a content sever 106, a video distribution site, etc.) may characterize objects determined and/or identified in step 924 with an importance value and/or a time having that importance value. For example, characterizing the objects with an importance value and/or a time (e.g., a duration, a number of frames, etc.) having that importance value may be based on correlating the objects detected in step 924 to objects in an object data table as described herein in FIG. 6. The time may be expressed in a temporal manner (e.g., as seconds, milliseconds, etc.) or may be expressed as a number (e.g., one or more) of frames of the plurality of video content.

Other characteristics of the content objects in the plurality of frames of video content may be determined. Position, size, and/or shape, for example, of the video content objects may be determined. Other areas of the video content may also be analyzed. An area may be predicted to be important (e.g., areas where action may occur) or unimportant (e.g., background areas and/or areas where action may likely not occur), for example, based on the importance values of video content objects in the area. Characteristics of the video content objects may be contained in a supplementary data file associated with the video (e.g., metadata) or an object data table as described herein in FIG. 6. A supplementary data file may comprise an importance value of video content objects and/or areas (e.g., regions, areas, etc.) in the video and a time the objects and/or areas may have that importance value. The time may be expressed in a temporal manner (e.g., as seconds) or as a frame count (e.g., one or more frames) of the plurality of frames of the video content.

In step 936 of FIG. 9B, a preliminary possible overlay position may be determined. The preliminary overlay position may be a primary overlay position, a preferred overlay position, and/or a recent (e.g., the last) overlay position. The primary overlay position may be defined by the rules packet. It may be determined by the video content provider. The primary overlay position may be a standard in the industry. A preferred overlay position may be an overlay position defined by a user and/or may be a setting. A recent overlay position may be the last overlay position and/or a position used most often in some period of time.

In step 940, it may be determined if any video content objects are within a preliminary overlay position. The preliminary position may be the first video content position to analyze for determination as a possible position for an overlay object that may obscure the video content. By having, and analyzing, the preliminary position, overlay objects may be overlaid over video content more consistently and limit random overlay positioning.

In step 944, it may be determined whether to obscure the preliminary overlay position. The determination of whether to obscure the preliminary overlay position may be based on, for example, the importance of the video content and the time the video content object(s) in the preliminary overlay position may be obscured. One or more frames of the video content, and the video content object(s) in those frames, may be analyzed. The analysis may determine that the video content object(s) in those frames will be important for a time period greater than the amount of time that the video content object(s) may be obscured by the overlay object. It may be determined to obscure a portion of a green, and the hole on the green, as a golfer lines up a putt, in step 944, for example, it if it determined that the golfer does not actually take their shot in the time that the overlay object may obscure the portion of the green and the hole. Similarly, analysis of one or more frames of video content, and the video content object(s) in those frames, may determine that within the time period that an overlay object obscures the video content object(s) the importance of the video content object(s) may change. It may be determined that a golfer may be about to tee off and strike a long drive with the ball travelling towards the green within the time the video content may be obscured, and based on the importance of the golf ball on the tee becoming less important and the importance of the golf ball travelling to the green becoming more important in the time that the overlay object obscures the video content, it may be determined, for example, to overlay the overlay object over the ball on the tee in favor of keeping the travel of the ball unobscured.

In step 944, it may be determined to go to step 980 of FIG. 9C, for example, if, based on the importance of the video content object(s) of the preliminary overlay position and the time the video content object(s) may be obscured, it is determined to obscure the preliminary overlay position. Alternatively, it may be determined to go to step 948 of FIG. 9B, for example, if, based on the importance of the video content object(s) of the preliminary overlay position and the time the video content object(s) may be obscured, it is determined not to obscure the preliminary overlay position.

In step 948, the preliminary overlay position may be determined to be the most likely overlay position. The most likely overlay position may be determined to be the overlay position, for example, if during analysis of video content positions, no positions are determined to be the overlay position. The most likely overlay position may be considered the reserve position of the video content to obscure. The most likely overlay position may be determined to be the overlay position, for example, if there is not an ultimate decision of a region of the video content to obscure. The most likely overlay position may be considered the most optimal region of the video content to obscure, for example, if no better region, of the video content, is determined to be obscured.

In step 952, objects that may have been determined, in step 920 of FIG. 9A, to be in the video content may be ranked. The objects may be ranked, for example, based on their importance value (e.g., as listed in an object table as described herein in FIG. 6). Other considerations may be made for rankings. Other considerations may comprise, for example, advertising agreements and/or sponsorship details. Rankings may be adjusted based on other factors related to the video content. A brand of golf clubs and/or a particular golfer may have their rankings increased for a particular golf tournament, for example, if the brand of golf clubs has a sponsorship relationship with the particular golfer and is a sponsor of the golf tournament.

Additionally, regions of the video content may have an associated importance value. An importance value associated with a region may be based on an importance value of video content objects in the region. The importance value associated with a region may be based on anticipated and/or projected importance. Video content objects with low importance at one point in a video content may become more important at a later time in the video content. For example, a green of a golf course may be unimportant, if there are no golf balls near it, but the green of the golf course may become important, once there is a golf ball on it.

Moreover, rankings other than by importance value may be made. A set of possible overlay positions may exist, for example, and the possible overlay positions may be analyzed to determine a position to overlay an overlay object. The set may consist, for example, of a preliminary possible overlay position, a secondary possible overlay position, etc. The set may comprise, for example, the bottom center of the video content, the bottom right of the video content, the bottom left of the video content, the top left of the video content, the top right of the video content, and/or the top center of the video content. The set may be determined based on the video content provider and/or the video content. A golf tournament may determine, for example, to have most, if not all, overlay objects to be on the third left of the video content, so may limit analysis of the video content to the third left of the video content.

In step 956 of FIG. 9C, a least important video content object and/or area (e.g., video content position) may be determined. The least important video content object and/or area may be determined to be a potential overlay position that may be analyzed based on its importance value and the time that it may be obscured.

In step 960, it may be determined whether to obscure the potential overlay object and/or area. The determination whether to obscure the potential overlay object and/or area may be based on the importance value of the potential overlay object and/or area and the time that the potential overlay object and/or area may be obstructed. The potential overlay object and/or area may have one or more reasons that it may be determined to not be suitable for obstruction. The potential overlay object and/or area may have significance to an advertiser and/or promoter, for example, if the advertiser and/or promoter had an agreement to not have certain video content objects and/or areas obstructed. Alternatively, certain areas of the video content may be prearranged to be for overlay objects regardless of the object(s) within the area. It may be agreed to by the promoter of a golf tournament, for example, to have the upper left corner be for golf statistics regardless of golfers and/or important object appearing in that area.

In determining whether to obscure the potential overlay object and/or area, one or more upcoming frames may be analyzed to determine how long the object and/or area remain important. This determination may factor into determining whether to overlay the object and/or area with the overlay object. A video content object that remains a part of the video content for a sufficiently long number of frames (e.g., for a sufficiently long period of time) may be obscured for a portion of that period of time, without any loss of information or viewing satisfaction to a viewer of the video content. Additionally, by analyzing one or more upcoming frames it may be determined that while the video content object is important at the moment, the object will not be important in future frames that may be covered. A golfer beginning their swing may be important up to and until the golf ball may be struck, for example, and a viewer may not be bothered if the view of the golfer is obstructed before the golf ball is hit.

In step 964, the currently most likely overlay position may be compared to the current potential overlay position. The comparison of the most likely overlay position with the current potential overlay position, for example, may be based on the importance value and the time that the overlay object may obscure the video content object and/or area. It may be determined that the most likely overlay position may remain the most likely overlay position, for example, if, based on the importance values of the most likely overlay position and the current potential overlay position and the time either may be obscured, a viewer would be less likely to have their viewing experience interfered with by selecting the current most likely overlay position. Alternatively, it may be determined that overlaying the overlay object over the current potential overlay position may become the most likely overlay position, for example, if, based on a comparison of the importance values of the most likely overlay position and the current potential overlay position, a viewer would be less likely to have their viewing experience interfered with by selecting the current potential overlay position.

In step 968, it may be determined whether there are more video content objects and/or areas to analyze for placement of the overlay object. It may be determination that a next least important video content object and/or area to analyze exists in step 972, for example, if there are more video content objects and/or areas to analyze (e.g., more video content objects and/or areas are on the ranked importance list of step 952 of FIG. 9B). Alternatively, the most likely overlay position may be determined to be the overlay position in step 976, for example, if there are no additional video content objects and or areas to analyze.

In step 972, a next least important video content object and/or area may be determined. The determination may be based on determining the next least important video content object and/or area that were ranked in step 952.

In step 976, the most likely overlay position may be determined to be the position of the video content to place the overlay object. The most likely overlay position may be selected, for example, if all the regions of the video content are determined to not be selected to the overlay object based on importance of the video content object and/or area and it was determined in step 968 that there are no more video content objects and/or areas to analyze.

In step 980, placement of the overlay object (e.g., an XML object, a TTML object, etc.) may be performed. Placement of the overlay object may be based on comparisons of the importance of video content objects and/or areas and the length of time of obstruction as determined in steps 920, 944, or 960. Specifically, the overlay objects may be positioned over regions with low importance values as determined in steps 916, 944, or 976. The position in the video content may be determined and the item inserted into the video content at the position, the region, the area, etc. in the video for the insertion period determined. An overlay object, may be placed over areas to enhance a viewer's experience, for example, by positioning objects to overlay over background areas where action is not likely to happen and/or may cover or obscure objects that may have been determined to be less important (e.g., have a lower importance value) in step 930.

The overlay object may be inserted over the determined objects and/or areas of one or more frames of the plurality of frames of video content. Overlaid video content may be generated, for example, with the overlaid video content comprising the plurality of frames of video content with the overlaid object inserted over a low importance region of the video content for one or more frames of the plurality of frames of video content. The computing device analyzing the video content and determining the placement of an overlay object over the video content may prepare video content to be played with the overlay object placed over the video content. Also, or alternatively, the computing device analyzing the video content and determining the placement of the overlay object over the video content may send the video content and a supplemental file comprising the overlay object and instructions of where to place the overlay object.

In step 984, the overlaid video content, with the overlay object overlaid over one or more frames of a low importance region of the plurality of frames of video content, may be displayed on one or more display devices. The overlaid video content may be displayed on a display device associated with a device performing the analysis of the video content. The overlaid video content may be transmitted to and displayed on a display device that may be different from the device performing the analysis of the video content. The overlaid video content may be stored and, at a time later than the time the analysis of the video content is performed, displayed on one or more devices associated with the device performing the analysis. The overlaid video content transmitted to and displayed on one or more devices associated with the devices different from the device performing the analysis at a time different than the analysis of the video content. The overlaid video content may be stored and/or saved on memory associated with and/or different than a computing device performing the analysis. The overlaid video content may be stored and/or saved, for example, on a content server 106.

In step 988 of FIG. 9A, it may be determined to repeat the steps outlined in step 908 through 984, while the video content is playing on a display device of a user. The computing device may utilize data determined previously, and retained on a memory storage device, as part of future analysis. Previous data may comprise, for example, determined video content objects and/or the time video content objects are important. Previous data may comprise prior overlay positions. Previous data may comprise overlay objects to repeat. A sponsor of a golf match may overlay a repeat advertisement, for example, during periods of low importance (e.g., the period just after a golfer sinks a putt and an advertisement break).

Additional data may also be inserted into the video content. Additional data may be determined using AI and/or an object data table as described herein in FIG. 6. Additional data may comprise data that may enhance the experience of a viewer of the video content. For example, a generated green (e.g., potential inserted data 810a of FIG. 8) and/or an anticipated path of a golf ball after being struck may be inserted. Additional data may be associated with sponsors of the content. Additional data may comprise details associated with content objects. Additional details may comprise details of an actor, for example, if the actor is currently in the video content and a viewer enabled more details to be shown.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, an overlay object for insertion into video content;
identifying, based on one or more first content objects identified in one or more frames of a plurality of frames of the video content, one or more regions of the one or more frames where future action of one or more second content objects is predicted to occur;
based on a first importance value corresponding to the one or more second content objects during a first time period, preventing output, in the video content, of the overlay object in the one or more regions during the first time period; and
based on a second importance value, different from the first importance value, corresponding to the one or more second content objects during a second time period after the first time period, causing, during the second time period, output of the video content with the overlay object inserted into the one or more regions.

2. The method of claim 1, wherein the overlay object comprises one or more of: a uniform resource locator (URL), a hashtag, a quick response (QR) code, information about the video content, identification of an individual in the video content, identification of a sponsor of the video content, an animation, an advertisement, a chyron, a nameplate, a picture-in-picture, a timed text markup language (TTML) object, a timer, a ticker, a caption, or a graphic.

3. The method of claim 1, wherein the video content comprises one or more of: sports content, news content, streaming video, animated content, interviews, award ceremonies, or entertainment content.

4. The method of claim 1, wherein the one or more first content objects comprise one or more of: a player in a sporting event, an individual in news content, a character or actor in entertainment content, an individual in an interview or awards show, a score box, a chyron, items or regions of the video content referenced or used by individuals of the video content, or a portion of a frame showing an advertisement.

5. The method of claim 1, wherein the causing output of the video content with the overlay object inserted into the one or more regions comprises sending, to a second computing device, the video content with the overlay object inserted into the one or more regions.

6. The method of claim 1, wherein the preventing output of the overlay object in the one or more regions comprises causing display of the overlay object in one or more second regions of the one or more frames.

7. The method of claim 1, further comprising:
determining a plurality of content objects present in at least a portion of the plurality of frames; and
selecting, from the plurality of content objects, the one or more first content objects.

8. The method of claim 1, further comprising:
selecting, based on one or more different importance values for one or more different content objects, one or more second regions of the one or more frames, wherein the preventing output of the overlay object in the one or more regions comprises causing display of the overlay object in the one or more second regions.

9. The method of claim 1, further comprising:
identifying the one or more first content objects by:
identifying, using a machine-learned algorithm trained using one or more of logistic regression, multi nominal logistics regression, linear regression, support vector machines, naive Bayes, decision trains, k nearest neighbors, random forest, boosting, k-means, or hierarchical clustering, a content object that appears, at least partially and for a period of time, in the plurality of frames of the video content.

10. The method of claim 1, wherein the first importance value indicates a priority value for the one or more second content objects to remain unobscured.

11. A method comprising:
determining, by a computing device, a plurality of content objects present in at least a portion of a plurality of frames of video content;
determining, for each of the plurality of content objects, an importance value that indicates a priority of the content object remaining unobscured;
identifying one or more first content objects, of the plurality of content objects, associated with highest importance values;
identifying, based on the one or more first content objects, one or more regions of the one or more frames, where future action of one or more second content objects, of the plurality of content objects, is predicted to occur;
based on a first importance value corresponding to the one or more second content objects during a first time period, preventing output, in the video content, of an overlay object in the one or more regions during the first time period; and
based on a second importance value, different from the first importance value, corresponding to the one or more second content objects during a second time period after the first time period, causing, during the second time period, output of the video content with the overlay object inserted into the one or more regions.

12. The method of claim 11, wherein the identifying the one or more first content objects associated with the highest importance values comprises:
receiving, for the video content, one or more potential content objects and an importance value for each of the one or more potential content objects;
determining one or more content objects, of the one or more potential content objects, in the video content;
determining, based on the importance values of the one or more potential content objects, an importance value for each of the one or more content objects in the video content; and
identifying the one or more first content objects by identifying, based on the determined importance values of the one or more content objects in the video content, the one or more content objects associated with the highest importance values.

13. The method of claim 11, further comprising:
determining, based on a size and shape of the overlay object, a size and shape of a region to be obscured by the overlay object; and
selecting, based on an insertion period and the size and shape of the region to be obscured, the one or more regions.

14. The method of claim 11, wherein the identifying the one or more first content objects associated with the highest importance values comprises:
determining a position for each of the one or more first content objects; and
determining an importance value for each of the one or more first content objects.

15. The method of claim 11, further comprising:
selecting the one or more regions based on a time period that the overlay object will at least partially obscure at least a portion of a plurality of frames of the video content.

16. The method of claim 11, further comprising receiving one or more rule packages that comprise one or more of a time period and a shape of a region, of at least a portion of a plurality of frames of the video content, to obscure.

17. A method comprising:
receiving, by a computing device, an overlay object, comprising an extensible markup language (XML) object, for insertion into video content;
identifying, in one or more frames of a plurality of frames of the video content, and by using a machine-learned algorithm, one or more first content objects to remain at least partially unobscured by the overlay object;
identifying, based on the one or more first content objects, one or more regions of the one or more frames, of the plurality of frames, where future action of one or more second content objects is predicted to occur;
based on a first importance value corresponding to the one or more second content objects during a first time period, preventing output, in the video content, of an overlay object in the one or more regions during the first time period; and
based on a second importance value, different from the first importance value, corresponding to the one or more second content objects during a second time period after the first time period, causing, during the second time period, output of the video content with the overlay object inserted into the one or more regions.

18. The method of claim 17, wherein the machine-learned algorithm was trained using one or more of logistic regression, multi nominal logistics regression, linear regression, support vector machines, naive Bayes, decision trains, k nearest neighbors, random forest, boosting, k-means, or hierarchical clustering, to identify content objects to remain at least partially unobscured by overlay objects.

19. The method of claim 17, wherein the XML object comprises one or more of: a uniform resource locator (URL), a hashtag, a quick response (QR) code, information about the video content, identification of an individual in the video content, identification of a sponsor of the video content, an animation, an advertisement, a chyron, a nameplate, a picture-in-picture, a timed text markup language (TTML) object, a timer, a ticker, or a graphic.

20. The method of claim 17, wherein the video content comprises one or more of:
sports content, news content, streaming video, animated content, interviews, award ceremonies, or entertainment content.
